(19) United States
(12) Patent Application Publication
(10) Pub. No.: US 2026/0017847 A1
(43) Pub. Date: Jan. 15, 2026

(54) IMAGE PROCESSING METHOD AND APPARATUS PERFORMING SAME

(71) Applicant: SAMSUNG ELECTRONICS CO., LTD., Suwon-si (KR)

(72) Inventors: Youngchan SONG, Suwon-si (KR); Soomin Kang, Suwon-si (KR); Kwanwoo Park, Suwon-si (KR); Iljun Ahn, Suwon-si (KR); Jaeyeon Park, Suwon-si (KR); Incheon Cho, Suwon-si (KR)

(73) Assignee: SAMSUNG ELECTRONICS CO., LTD., Suwon-si (KR)

(21) Appl. No.: 19/338,501

(22) Filed: Sep. 24, 2025

Related U.S. Application Data
(63) Continuation of application No. PCT/KR2024/002618, filed on Feb. 29, 2024.

(30) Foreign Application Priority Data
Apr. 5, 2023 (KR) 10-2023-0045039
Dec. 28, 2023 (KR) 10-2023-0195360

(51) Int. Cl. G06T 11/00; G06V 10/77

(52) U.S. Cl. CPC G06T 11/00; G06V 10/7715

(57) ABSTRACT

A method of processing an image includes extracting first feature data from a first image, obtaining second feature data by applying, to the first feature data, a first transformation associated with a first parameter, obtaining third feature data by applying, to the second feature data, a second transformation associated with a second parameter, obtaining fourth feature data by performing first image processing on the second feature data and the third feature data, obtaining fifth feature data by applying, to the fourth feature data, a third transformation associated with a third parameter, obtaining sixth feature data by performing second image processing on the second feature data and the fifth feature data, and generating a second image based on the sixth feature data. The first through third parameters are determined based on a comparison of ratios of the parameters with a predetermined value.

### CROSS-REFERENCE TO RELATED APPLICATIONS

This application is a continuation application of International Application No. PCT/KR2024/002618, filed on Feb. 29, 2024, which claims priority to Korean Provisional Application No. 10-2023-0045039, filed on Apr. 5, 2023, and to Korean Patent Application No. 10-2023-0195360, filed on Dec. 28, 2023, in the Korean Intellectual Property Office, the disclosures of which are incorporated by reference herein in their entireties.

### BACKGROUND

### 1. Field

The present disclosure relates generally to image processing, and more particularly, to an image processing method and an apparatus for performing the same.

### 2. Description of Related Art

As data traffic has increased exponentially with the development of computer technology, artificial intelligence (AI) technology may have become an important trend for potentially driving future innovations. As AI technology attempts to similar human thinking, AI technologies may be applicable to a large and varied swath of industries. Representative examples of AI technology may include, but not be limited to, pattern recognition, machine learning, expert systems, neural networks, natural language processing, or the like.

Neural networks may model certain characteristics of human biological nerve cells by using mathematical expressions and may use learning algorithms that may mimic human learning abilities. Through these learning algorithms, neural networks may be able to generate mappings between input data and output data. Such an ability to generate these mappings may be referred to as a learning capability of a neural network. Furthermore, neural networks may have a generalization ability to generate, based on training (or learning) results, correct output data with respect to input data that may not have been used during its training.

A neural network may be used for image processing. For example, a neural network may be used to remove noise and/or artifacts from an image and/or may be used to increase the resolution of the image.

### SUMMARY

According to an aspect of the present disclosure, a method of processing an image includes extracting first feature data from a first image, obtaining second feature data by applying, to the first feature data, a first transformation associated with a first parameter, obtaining third feature data by applying, to the second feature data, a second transformation associated with a second parameter, obtaining fourth feature data by performing first image processing on the second feature data and the third feature data, obtaining fifth feature data by applying, to the fourth feature data, a third transformation associated with a third parameter, obtaining sixth feature data by performing second image processing on the second feature data and the fifth feature data, and generating a second image based on the sixth feature data. The method further includes determining the first parameter, the second parameter, and the third parameter based on a first difference between a first ratio of the second parameter to the first parameter and a second ratio of the third parameter to the first parameter being greater than or equal to a predetermined value.

In an embodiment, the performing of the first image processing may include obtaining query data based on the third feature data, obtaining key data and value data based on the second feature data, calculating a weight matrix based on the query data and the key data, and obtaining the fourth feature data based on the weight matrix and the value data.

In an embodiment, the generating of the second image may include determining a fourth parameter based on the first parameter, a resolution of the first image, and a resolution of the second image, obtaining seventh feature data by applying, to the second feature data, a fourth transformation associated with the fourth parameter, obtaining eighth feature data by applying, to the sixth feature data, a fifth transformation associated with a fifth parameter, obtaining ninth feature data by performing third image processing on the seventh feature data and the eighth feature data, obtaining tenth feature data by applying, to the ninth feature data, a sixth transformation associated with a sixth parameter, obtaining eleventh feature data by performing fourth image processing on the seventh feature data and the tenth feature data, and generating the second image based on the eleventh feature data.

In an embodiment, the method may further include determining the fifth parameter and the sixth parameter based on a second difference between a third ratio of the fifth parameter to the fourth parameter and a fourth ratio of the sixth parameter to the fourth parameter being less than the first difference.

In an embodiment, the generating of the second image may include obtaining twelfth feature data by applying, to the sixth feature data, a seventh transformation associated with a seventh parameter, obtaining thirteenth feature data by performing fifth image processing on the sixth feature data and the twelfth feature data, obtaining fourteenth feature data by applying, to the thirteenth feature data, an eighth transformation associated with an eighth parameter, obtaining fifteenth feature data by performing sixth image processing on the sixth feature data and the fourteenth feature data, and generating the second image, based on the fifteenth feature data.

In an embodiment, the method may further include determining the seventh parameter and the eighth parameter based on a third difference between a fifth ratio of the seventh parameter to the second parameter and a sixth ratio of the eighth parameter to the second parameter being less than the first difference between the first ratio and the second ratio.

In an embodiment, each of the first transformation, the second transformation, the third transformation, the fourth transformation, the fifth transformation, the sixth transformation, the seventh transformation, and the eighth transformation may include a scaling transformation, and each of the first parameter, the second parameter, the third parameter, the fourth parameter, the fifth parameter, the sixth parameter, the seventh parameter, and the eighth parameter may include a scale factor.

According to an aspect of the present disclosure, an image processing apparatus includes one or more processors including processing circuitry, and memory storing instructions. The instructions, when executed by the one or more processors individually or collectively, cause the image processing apparatus to extract first feature data from a first image, obtain second feature data by applying, to the first feature data, a first transformation associated with a first parameter, obtain third feature data by applying, to the second feature data, a second transformation associated with a second parameter, obtain fourth feature data by performing first image processing on the second feature data and the third feature data, obtain fifth feature data by applying, to the fourth feature data, a third transformation associated with a third parameter, obtain sixth feature data by performing second image processing on the second feature data and the fifth feature data, generate a second image, based on the sixth feature data, and determine the first parameter, the second parameter, and the third parameter based on a first difference between a first ratio of the second parameter to the first parameter and a second ratio of the third parameter to the first parameter being greater than or equal to a predetermined value.

In an embodiment, the instructions, when executed by the one or more processors individually or collectively, may further cause the image processing apparatus to obtain query data based on the third feature data, obtain key data and value data, based on the second feature data, calculate a weight matrix based on the query data and the key data, and obtain the fourth feature data based on the weight matrix and the value data.

In an embodiment, the instructions, when executed by the one or more processors individually or collectively, may further cause the image processing apparatus to determine a fourth parameter based on the first parameter, a resolution of the first image, and a resolution of the second image, obtain seventh feature data by applying, to the second feature data, a fourth transformation associated with the fourth parameter, obtain eighth feature data by applying, to the sixth feature data, a fifth transformation associated with a fifth parameter, obtain ninth feature data by performing third image processing on the seventh feature data and the eighth feature data, obtain tenth feature data by applying, to the ninth feature data, a sixth transformation associated with a sixth parameter, obtain eleventh feature data by performing fourth image processing on the seventh feature data and the tenth feature data, and generate the second image based on the eleventh feature data.

In an embodiment, the instructions, when executed by the one or more processors individually or collectively, may further cause the image processing apparatus to determine the fifth parameter and the sixth parameter based on a second difference between a third ratio of the fifth parameter to the fourth parameter and a fourth ratio of the sixth parameter to the fourth parameter being less than the first difference.

In an embodiment, the instructions, when executed by the one or more processors individually or collectively, may further cause the image processing apparatus to obtain twelfth feature data by applying, to the sixth feature data, a seventh transformation associated with a seventh parameter, obtain thirteenth feature data by performing fifth image processing on the sixth feature data and the twelfth feature data, obtain fourteenth feature data by applying, to the thirteenth feature data, an eighth transformation associated with an eighth parameter, obtain fifteenth feature data by performing sixth image processing on the sixth feature data and the fourteenth feature data, and generate the second image based on the fifteenth feature data.

In an embodiment, the instructions, when executed by the one or more processors individually or collectively, may further cause the image processing apparatus to determine the seventh parameter and the eighth parameter based on a third difference between a fifth ratio of the seventh parameter to the second parameter and a sixth ratio of the eighth parameter to the second parameter being less than the first difference.

In an embodiment, each of the first transformation, the second transformation, the third transformation, the fourth transformation, the fifth transformation, the sixth transformation, the seventh transformation, and the eighth transformation may include a scaling transformation, and each of the first parameter, the second parameter, the third parameter, the fourth parameter, the fifth parameter, the sixth parameter, the seventh parameter, and the eighth parameter may include a scale factor.

According to an aspect of the present disclosure, a non-transitory computer-readable recording medium having recorded thereon one or more instructions for processing an image that, when executed by at least one processor of a device, cause the device to extract first feature data from a first image, obtain second feature data by applying, to the first feature data, a first transformation associated with a first parameter, obtain third feature data by applying, to the second feature data, a second transformation associated with a second parameter, obtain fourth feature data by performing first image processing on the second feature data and the third feature data, obtain fifth feature data by applying, to the fourth feature data, a third transformation associated with a third parameter, obtain sixth feature data by performing second image processing on the second feature data and the fifth feature data, generate a second image, based on the sixth feature data, and determine the first parameter, the second parameter, and the third parameter based on a first difference between a first ratio of the second parameter to the first parameter and a second ratio of the third parameter to the first parameter being greater than or equal to a predetermined value.

In an embodiment, the one or more instructions, when executed by the at least one processor of the device, may further cause the device to obtain query data based on the third feature data, obtain key data and value data, based on the second feature data, calculate a weight matrix based on the query data and the key data, and obtain the fourth feature data based on the weight matrix and the value data.

In an embodiment, the one or more instructions, when executed by the at least one processor of the device, may further cause the device to determine a fourth parameter based on the first parameter, a resolution of the first image, and a resolution of the second image, obtain seventh feature data by applying, to the second feature data, a fourth transformation associated with the fourth parameter, obtain eighth feature data by applying, to the sixth feature data, a fifth transformation associated with a fifth parameter, obtain ninth feature data by performing third image processing on the seventh feature data and the eighth feature data, obtain tenth feature data by applying, to the ninth feature data, a sixth transformation associated with a sixth parameter, obtain eleventh feature data by performing fourth image processing on the seventh feature data and the tenth feature data, and generate the second image based on the eleventh feature data.

In an embodiment, the one or more instructions, when executed by the at least one processor of the device, may further cause the device to determine the fifth parameter and the sixth parameter based on a second difference between a third ratio of the fifth parameter to the fourth parameter and a fourth ratio of the sixth parameter to the fourth parameter being less than the first difference.

In an embodiment, the one or more instructions, when executed by the at least one processor of the device, may further cause the device to obtain twelfth feature data by applying, to the sixth feature data, a seventh transformation associated with a seventh parameter, obtain thirteenth feature data by performing fifth image processing on the sixth feature data and the twelfth feature data, obtain fourteenth feature data by applying, to the thirteenth feature data, an eighth transformation associated with an eighth parameter, obtain fifteenth feature data by performing sixth image processing on the sixth feature data and the fourteenth feature data, and generate the second image based on the fifteenth feature data.

In an embodiment, the one or more instructions, when executed by the at least one processor of the device, may further cause the device to determine the seventh parameter and the eighth parameter based on a third difference between a fifth ratio of the seventh parameter to the second parameter and a sixth ratio of the eighth parameter to the second parameter being less than the first difference.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a diagram of an image processing network, according to an embodiment;

FIG. 2 is a block diagram of a structure of a second feature extraction module, according to an embodiment;

FIG. 3A is a block diagram of a structure of a transformer group, according to an embodiment;

FIG. 3B is a block diagram of a structure of a transformer group, according to an embodiment;

FIG. 4 is a block diagram of a structure of a transformer group, according to an embodiment;

FIG. 5 is a block diagram of a structure of a transformer layer, according to an embodiment;

FIG. 6 is a block diagram of a structure of an attention module, according to an embodiment;

FIG. 7 is a block diagram of a structure of a multi-layer perceptron (MLP) module, according to an embodiment;

FIG. 8 illustrates a scaling factor, according to an embodiment;

FIG. 9 is a flowchart of an image processing method, according to an embodiment;

FIG. 10 is a block diagram of an image processing apparatus, according to an embodiment;

### DETAILED DESCRIPTION

Throughout the present disclosure, the expression “at least one of a, b and c” indicates only a, only b, only c, both a and b, both a and c, both b and c, all of a, b, and c, or variations thereof.

Although general terms widely used at present were selected for describing the present disclosure in consideration of the functions thereof, these general terms may vary according to intentions of one of ordinary skill in the art, case precedents, the advent of new technologies, or the like. Terms arbitrarily selected by the Applicant of the present disclosure may also be used in a specific case. In this case, their meanings need to be given in the detailed description of the present disclosure. Hence, the terms may be understood based on their meanings and the contents of the entire specification, not by simply stating the terms.

While terms such as “first,” “second,” or the like, may be used to describe various components, such components may not be limited to the above terms. The above terms are used only to distinguish one component from another. For example, a first component discussed below may be termed a second component, and similarly, a second component may be termed a first component without departing from the teachings of embodiments.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

Unless the context clearly indicates otherwise, the singular forms “a”, “an,” and “the” are to be understood to include a plurality of referents. Thus, for example, reference to “a component surface” may also include reference to one or “more of such surfaces”.

An expression used in the singular may encompass the expression in the plural, unless it has a clearly different meaning in the context. Unless otherwise defined, all terms (including technical and scientific terms) used herein have the same meaning as commonly understood by one of ordinary skill in the art to which the present disclosure belongs.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

In the present disclosure, it is to be understood that the terms such as, but not limited to, “including”, “having”, and “comprising” are intended to indicate the existence of the features, numbers, steps, actions, components, parts, or combinations thereof disclosed in the present disclosure, and are not intended to preclude the possibility that one or more other features, numbers, steps, actions, components, parts, or combinations thereof may exist or may be added.

Regarding a component represented as a “portion (unit)” or a “module” used herein, two or more components may be combined into one component or one component may be divided into two or more components according to subdivided functions. In addition, each component described hereinafter may additionally perform some or all of functions performed by another component, in addition to main functions of itself, and some of the main functions of each component may be performed entirely by another component.

All functions or operations described herein may be processed by a single processor or a combination of processors. The processor or combination of processors may be and/or may include circuitry that may perform processing, and may include circuitry such as, but not limited to, an application processor (AP), a communication processor (CP), a graphics processing unit (GPU), a neural processing unit (NPU), a microprocessor unit (MPU), a system on chip (SoC), an integrated chip (IC), or the like.

In the present disclosure, functions related to artificial intelligence (AI) may be operated through a processor and a memory. The processor may include one or a plurality of processors. The one or plurality of processors may be a general-purpose processor such as, but not limited to, a central processing unit (CPU), an application processor (AP), or a digital signal processor (DSP), a graphics-only processor such as, but not limited to, a graphics processing unit (GPU) or a vision processing unit (VPU), or an AI-only processor such as, but not limited to, a neural processing unit (NPU). The one or plurality of processors may process input data according to a predefined operation rule or AI model stored in the memory. Alternatively, when the one or plurality of processors are AI-only processors, the AI-only processors may be designed in a hardware structure specialized for processing a specific AI model.

The predefined operation rule or AI model may be characterized in that it may be created through learning. As used herein being created through learning may indicate that a basic AI model may have been learned using a plurality of learning data by a learning algorithm, so that a predefined operation rule or AI model set to perform desired characteristics (or a purpose) may be created. Such learning may be performed in a device itself on which AI, according to the present disclosure, is performed, and/or may be performed through a separate server and/or system. Examples of learning algorithms may include, but may not be limited to, supervised learning, unsupervised learning, semi-supervised learning, reinforcement learning, or the like.

The AI model may be composed of a plurality of neural network layers. Each of the plurality of neural network layers may have a plurality of weight values, and may perform a neural network operation through an operation between an operation result from a previous layer and the plurality of weight values. The plurality of weight values included in the plurality of neural network layers may be optimized by a learning result of the AI model. For example, the plurality of weight values may be updated so that a loss value and/or a cost value obtained from the AI model is reduced or minimized during a learning process. An artificial neural network may include a deep neural network (DNN), for example, a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), or a Deep Q-Network (DQN). However, embodiments of the present disclosure are not limited thereto.

In the present disclosure, a machine-readable storage medium may be provided in the form of a non-transitory storage medium. A “non-transitory storage medium” refers to a tangible device and only means that it does not contain a signal (e.g., electromagnetic waves). This term does not distinguish a case in which data is stored semi-permanently in a storage medium from a case in which data is temporarily stored. For example, the non-transitory recording medium may include a buffer in which data is temporarily stored.

In the present disclosure, it is to be understood that blocks in each flowchart and combinations of flowcharts may be performed by one or more computer programs including computer-executable instructions. The one or more computer programs may be all stored in a single memory, or may be partitioned and stored in a number of different memories.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented

According to an embodiment, methods may be provided by being included in a computer program product. The computer program product, which is a commodity, may be traded between sellers and buyers. Computer program products are distributed in the form of device-readable storage media (e.g., compact disc read only memory (CD-ROM)), or may be distributed (e.g., downloaded or uploaded) through an application store or between two user devices (e.g., smartphones) directly and online. In the case of online distribution, at least a portion of the computer program product (e.g., a downloadable app) may be stored at least temporarily in a device-readable storage medium, such as, but not limited to, a memory of a manufacturer's server, a server of an application store, or a relay server, or may be temporarily generated.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Embodiments of the present disclosure are described with reference to the accompanying drawings so that the present disclosure may be easily performed by one of ordinary skill in the art to which the present disclosure pertains. The present disclosure may, however, be embodied in many different forms and may not be construed as being limited to the embodiments set forth herein.

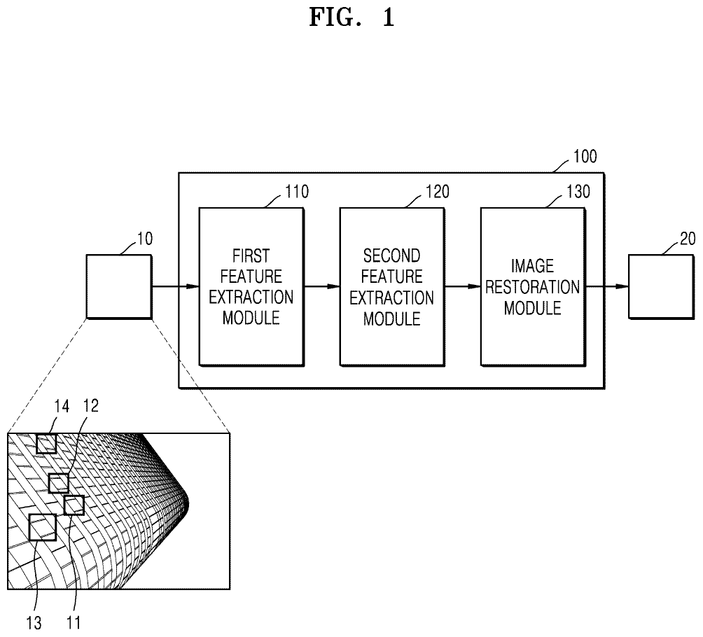

FIG. 1 is a diagram of an image processing network, according to an embodiment.

Referring to FIG. 1, an image processing network 100 may receive a first image 10 and may process the first image 10 to generate a second image 20. According to an embodiment, the first image 10 may be an image including noise or artifacts, a low-resolution image, and/or a low-quality image. According to an embodiment, the second image 20 may be an image obtained by removing noise or artifacts from the first image 10, an image with a higher resolution than the first image 10, and/or an image with a higher quality than the first image 10.

According to an embodiment, the image processing network 100 may generate the second image 20 by using repetitive information included in the first image 10. The repetitive information may include an object, line, or edge that may be identical with and/or substantially similar to each other in size, shape, and/or structure. According to an embodiment, the repetitive information may include objects, lines, or edges that may be identical to each other in shape and may be different from each other in size. According to an embodiment, the repetitive information may include objects, lines, or edges having a geometrically transformed shape. For example, the repetitive information may include an object of a first shape and an object of a second shape obtained by performing an affine transformation on the first shape.

For example, referring to FIG. 1, in order to process a target object 11, the image processing network 100 may utilize a first object 12 having the same size, shape, and structure as the target object 11, a second object 13 having the same shape as but different size from the target object 11, and a third object 14 having an affine-transformed shape of the target object 11.

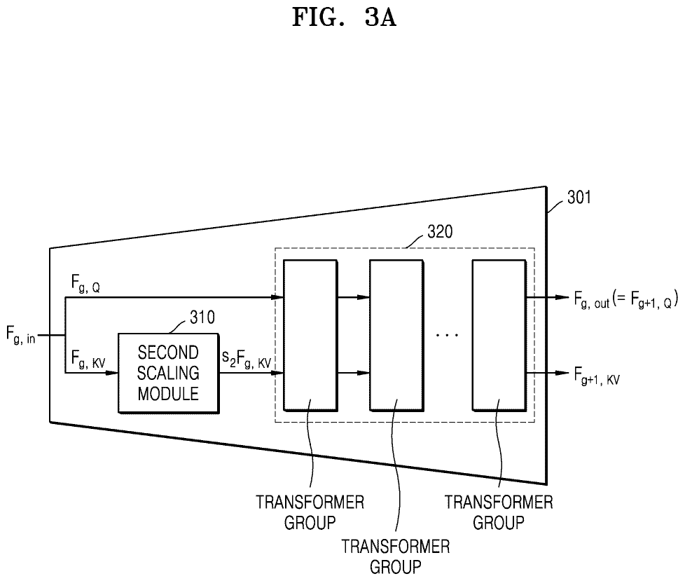

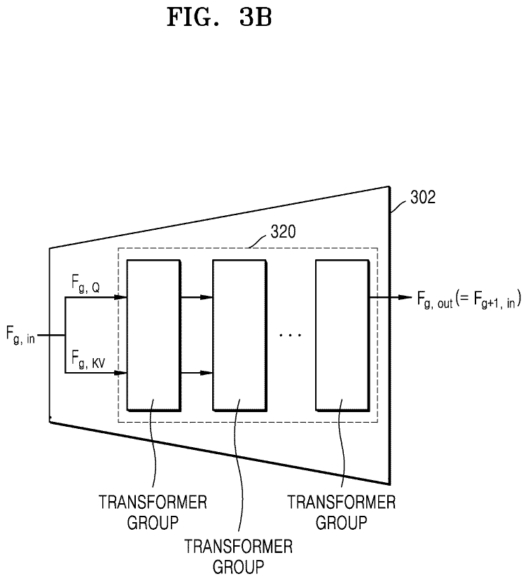

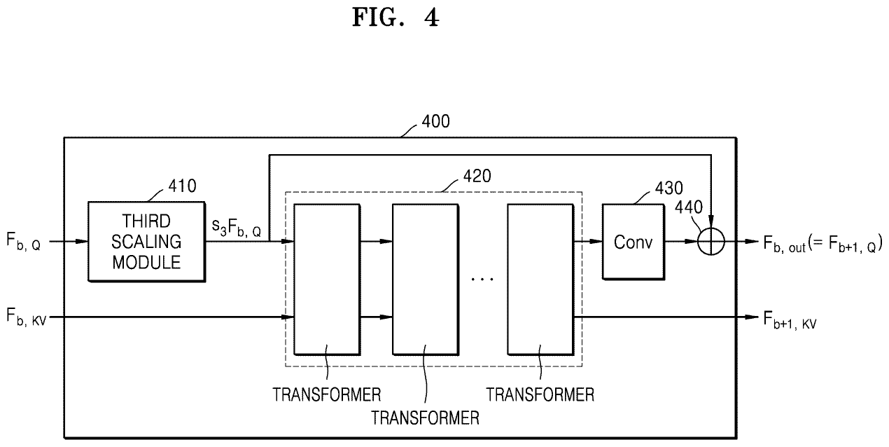

According to an embodiment, the image processing network 100 may utilize the repetitive information included in the first image 10 by applying a predetermined transformation to the first image 10 (or features extracted from the first image 10). For example, the predetermined transformation may include, but is not limited to, scaling, similarity transformation, Euclidean transformation, affine transformation, and projective transformation. For example, the image processing network 100 may scale the first image 10 (or features corresponding to the first image 10) by using a second scaling module 310 of FIG. 3A and a third scaling module 410 of FIG. 4. Respective operations of the second scaling module 310 of FIG. 3A and the third scaling module 410 of FIG. 4 are described with reference to FIG. 3A and FIG. 4, respectively.

According to an embodiment, the image processing network 100 may include a first feature extraction module 110, a second feature extraction module 120, and an image restoration module 130. However, a structure of the image processing network 100 is not limited thereto.

According to an embodiment, the first feature extraction module 110 may extract a feature corresponding to the first image 10 from the first image 10. The first feature extraction module 110 may include one or more convolutional neural networks (CNNs).

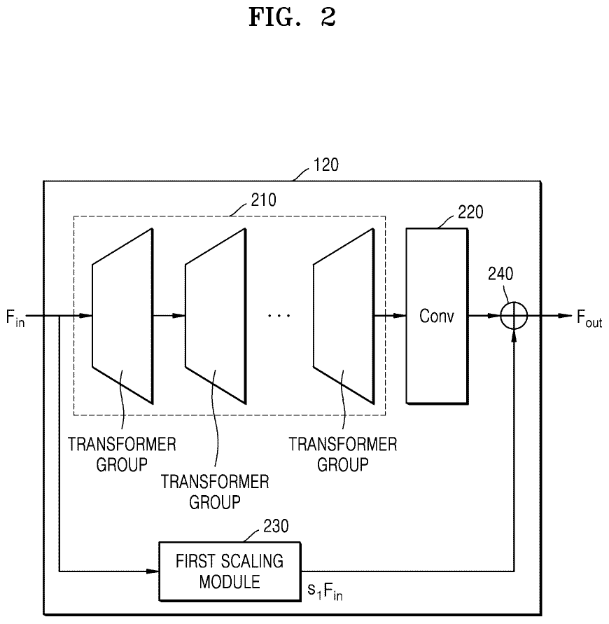

According to an embodiment, the second feature extraction module 120 may extract a higher-dimensional feature, based on the feature extracted by the first feature extraction module 110. The second feature extraction module 120 may include one or more neural networks. A structure and an operation of the second feature extraction module 120 are described with reference to FIGS. 2, 3A, 3B, and 4 through 8.

According to an embodiment, the image restoration module 130 may generate the second image 20, based on the higher-dimensional feature extracted by the second feature extraction module 120. The image restoration module 130 may include one or more convolutional neural networks.

According to an embodiment, the image restoration module 130 may generate the second image 20 by mapping feature data of a feature space extracted by the second feature extraction module 120 with an image space. As further described below, because the second feature extraction module 120 extract the higher-dimensional feature while gradually upscaling the feature extracted by the first feature extraction module 110, the image restoration module 130 may generate the second image 20 without upscaling input feature data.

FIG. 2 is a block diagram of a structure of a second feature extraction module, according to an embodiment.

Referring to FIG. 2, the second feature extraction module 120 may include one or more transformer groups 210, a convolutional layer 220, a first scaling module 230, and a summation layer 240.

According to an embodiment, the one or more transformer groups 210 may perform image processing on input data Fin input to the one or more transformer groups 210. The input data Fin input to the one or more transformer groups 210 may be feature data extracted by the first feature extraction module 110. Each of the one or more transformer groups 210 may receive output data of a previous transformer group and may perform image processing on the output data of the previous transformer group. According to an embodiment, each of the one or more transformer groups 210 illustrated in FIG. 2 may be and/or may include a transformer group 301 illustrated in FIG. 3A. According to an embodiment, each of the one or more transformer groups 210 illustrated in FIG. 2 may be a transformer group 302 illustrated in FIG. 3B. Respective structures and respective operations of the transformer groups 301 (see FIG. 3A) and 302 (see FIG. 3B) are described below with reference to FIGS. 3A and 3B, respectively.

According to an embodiment, the convolutional layer 220 may perform a convolution operation between input data input to the convolutional layer 220 and a kernel included in the convolutional layer 220. The input data input to the convolutional layer 220 may be feature data generated as a result of image processing performed by the one or more transformer groups 210. In FIG. 2, the second feature extraction module 120 is illustrated as including one convolutional layer 220. However, the number of convolutional layers 220 is not limited thereto, and the second feature extraction module 120 may include two (2) or more convolutional layers.

According to an embodiment, the first scaling module 230 may scale input data input to the first scaling module 230 by using a predetermined scale factor s₁. The input data input to the first scaling module 230 may be a feature extracted by the first feature extraction module 110.

According to an embodiment, the scale factor s₁ of the first scaling module 230 may be determined based on the resolution of the first image 10 and the resolution of the second image 20. For example, when the resolution of the first image 10 is M×N and the resolution of the second image 20 is 4M×4N, the scale factor s₁ of the first scaling module 230 may be determined as 4.

According to an embodiment, the summation layer 240 may perform an element-wise summation operation between output data of the convolutional layer 220 and output data of the first scaling module 230. Output data Fout of the summation layer 240 may be input to the image restoration module 130.

FIG. 3A is a block diagram of a structure of a transformer group, according to an embodiment.

The transformer group 301 of FIG. 3A may include and/or may be similar in many respects to one of the one or more transformer groups 210 of FIG. 2, and may include additional features not mentioned above. Consequently, repeated descriptions of the transformer group 301 described above with reference to FIG. 2 may be omitted for the sake of brevity.

Referring to FIG. 3A, the transformer group 301 may include a second scaling module 310 and one or more transformer blocks 320.

According to an embodiment, the second scaling module 310 may scale input data input F_{g, KV} by using a predetermined scale factor s₂. The input data F_{g, KV} input to the second scaling module 310 may be first input data F_{g, in} input to the transformer group 301. The first input data F_{g, in} input to the transformer group 301 may be feature data extracted by the first feature extraction module 110.

According to an embodiment, the one or more transformer blocks 320 may perform image processing on first input data F_{g, Q} and second input data s₂F_{g, KV}. The first input data F_{g, Q} input to the one or more transformer blocks 320 may be the first input data F_{g, in} input to the transformer group 301. The second input data s₂F_{g, KV} input to the one or more transformer groups 320 may be output data of the second scaling module 310. A structure and operation of a transformer block is further described with reference to FIG. 4.

According to an embodiment, the transformer group 301 may output first output data F_{g, out} and second output data F_{g+1, KV}. When the second feature extraction module 120 includes a plurality of transformer groups, for a natural number g (e.g., a positive integer greater than zero (0)), the first output data Fg, out of a g-th transformer group 301 may be input to a (g+1)-th transformer group as first input data F_{g+1, Q} of the (g+1)-th transformer group, and the second output data F_{g+1, KV} of the g-th transformer group 301 may be input to the (g+1)-th transformer group as input data of a second scaling module of the (g+1)-th transformer group.

According to an embodiment, when the second feature extraction module 120 includes a plurality of transformer groups 301, respective scale factors of second scaling modules respectively included in the transformer groups 301 may be different from each other. For example, when the resolution (e.g., a target scale) of the second image 20 is four times (e.g., 4×) the resolution of the first image and the second feature extraction module 120 includes three (3) transformer groups, a scale factor of a second scaling module included in a first transformer group may be one (1), a scale factor of a second scaling module included in a second converter group may be two (2), and a scale factor of a second scaling module included in a third converter group may be three (3).

FIG. 3B is a block diagram of a structure of a transformer group, according to an embodiment.

The transformer group 302 of FIG. 3B may include and/or may be similar in many respects to one of the one or more transformer groups 210 of FIG. 2, and may include additional features not mentioned above. Consequently, repeated descriptions of the transformer group 302 described above with reference to FIG. 2 may be omitted for the sake of brevity.

Referring to FIG. 3B, the transformer group 302 may include one or more transformer blocks 320.

According to an embodiment, the one or more transformer blocks 320 may perform image processing on the first input data F_{g, Q} and the second input data F_{g, KV}. The first input data F_{g, Q} input to the one or more transformer blocks 320 may be the first input data F_{g, in} input to the transformer group 302. The first input data F_{g, KV} input to the one or more transformer blocks 320 may be the first input data F_{g, in} input to the transformer group 302.

According to an embodiment, the transformer group 302 may output output data F_{g, out}. When the second feature extraction module 120 includes a plurality of transformer groups, for the natural number g, output data F_{g, out} of a g-th transformer group 302 may be input to a (g+1)-th transformer group as input data F_{g+1, Q} of the (g+1)-th transformer group.

As further described below, the output data F_{g, out} of the transformer group 302 is a result of scaling of the first input data F_{g, Q} input to the one or more transformer blocks 320 by the one or more converter blocks 320. For a natural number g, the scaled output data F_{g, out} in the g-th transformer group 302 may be used as second input data F_{g+1, KV} of one or more transformer blocks included in the (g+1)-th transformer group 302.

The transformer group 301 of FIG. 3A may use the feature data extracted by the first feature extraction module 110 as second input data of the one or more transformer blocks 320 after scaling the extracted feature data by using the second scaling module 310, while the transformer group 302 of FIG. 3B uses feature data updated by a previous transformer group 302 as second input data of the one or more transformer blocks 320. Accordingly, the transformer group 302 of FIG. 3B may utilize feature data incrementally updated by previous transformer groups 302 instead of utilizing initially generated feature data.

FIG. 4 is a block diagram of a structure of a transformer group, according to an embodiment.

A transformer group 400 of FIG. 4 may include and/or may be similar in many respects to one or more transformer groups 320 of FIGS. 3A and 3B, and may include additional features not mentioned above. Consequently, repeated descriptions of the transformer group 400 described above with reference to FIGS. 3A and 3B may be omitted for the sake of brevity.

Referring to FIG. 4, the transformer group 400 may include a third scaling module 410, one or more transformer blocks 420, a convolutional layer 430, and a summation layer 440.

According to an embodiment, the third scaling module 410 may scale input data input by using a predetermined scale factor s₃. The input data input to the third scaling module 410 may be first input data F_{b, Q} input to the transformer group 400. The first input data F_{b, Q} input to the transformer block 400 may be the first input data F_{g, Q} input to the one or more transformer blocks 320.

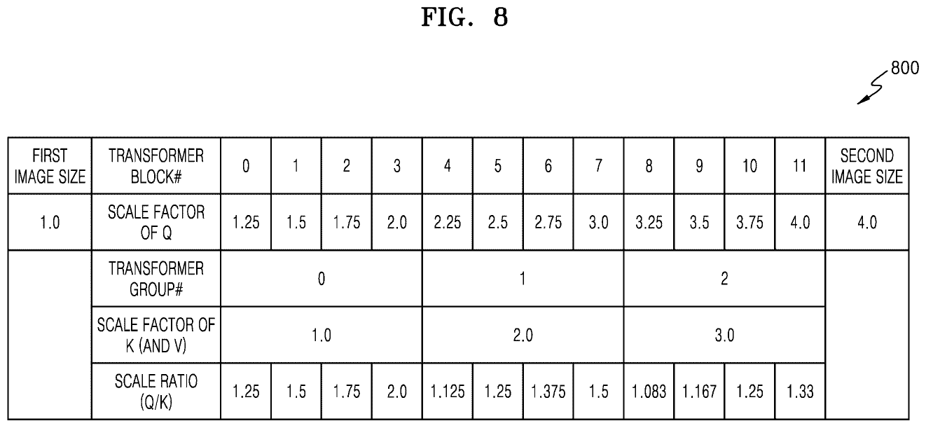

According to an embodiment, when the transformer group 301 includes a plurality of transformer groups 500, respective scale factors of third scaling modules respectively included in transformer groups 400 may be different from each other. For example, when the transformer group 301 includes four transformer blocks, and, when a scale factor of the second scaling module 310 included in the transformer group 301 is one (1), a scale factor of a third scaling module included in a first transformer block may be 1.25, when a scale factor of a third scaling module included in a second transformer block may be 1.5, when a scale factor of a third scaling module included in a third transformer block may be 1.75, and, when a scale factor of a third scaling module included in a fourth transformer block may be 2.0. However, embodiments of the present disclosure are not limited in this regard. A determination of the scale factor s₂ of the second scaling module 310 included in the transformer group 301 and the scale factor s₃ of the third scaling module 410 included in the transformer block 400 is further described with reference to FIG. 8.

According to an embodiment, the transformer group 400 may output first output data F_{b, out} and second output data F_{b+1, KV}. When the transformer groups 301 and 302 include a plurality of transformer groups, for a natural number b (e.g., a positive integer greater than zero (0)), first output data F_{b, out} of a b-th transformer group 400 may be input to a (b+1)-th transformer group as first input data F_{b+1, Q} of the (b+1)-th transformer group, and second output data F_{b+1, KV} of the g-th transformer group 400 may be input to the (b+1)-th transformer group as second input data of the (g+1)-th transformer group.

According to an embodiment, the second output data F_{b+1, KV} of the transformer group 400 may be second input data F_{b, KV} of the transformer group 400 that has been bypassed. That is, the second output data F_{b+1, KV} of the transformer group 400 may be the same as the second input data F_{b, KV} of the transformer group 400. A plurality of transformer blocks included in one transformer group may all perform image processing on the same second input data.

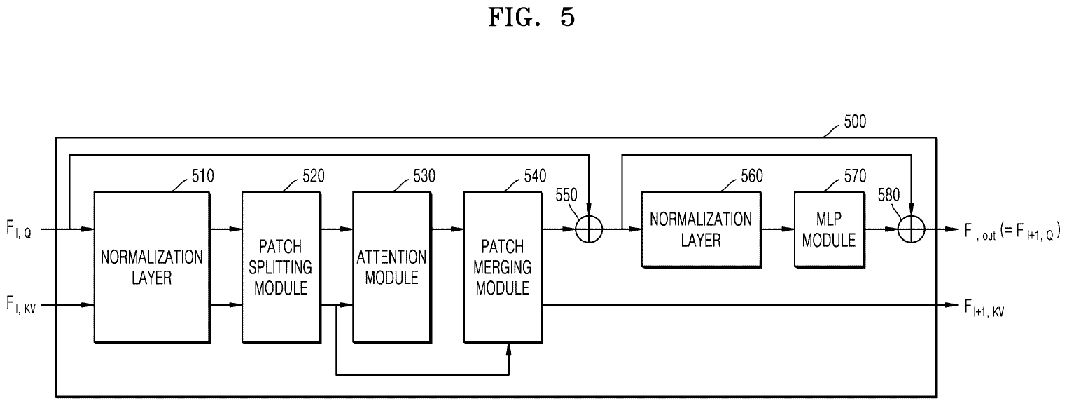

According to an embodiment, the one or more transformer blocks 420 may perform image processing on the first input data s₃F_{b, Q} and the second input data F_{b, KV}. The first input data s₃F_{b, Q} input to the one or more transformer layers 420 may be output data of the third scaling module 410. The second input data F_{b, KV} input to the one or more transformer layers 420 may be the second input data F_{b, KV} input to the transformer group 400. A structure and an operation of a transformer layer is further described with reference to FIGS. 5 through 8.

According to an embodiment, the convolutional layer 430 may perform a convolution operation between input data input to the convolutional layer 430 and a kernel included in the convolutional layer 430. The input data input to the convolutional layer 430 may be feature data generated as a result of image processing performed by the one or more transformer layers 420. In FIG. 4, the transformer group 400 is illustrated as including one convolutional layer 430. However, the number of convolutional layers 430 is not limited thereto, and the transformer group 400 may include two (2) or more convolutional layers.

According to an embodiment, the summation layer 440 may perform an element-wise summation operation between output data of the convolutional layer 430 and output data of the third scaling module 410. The output data of the summation layer 440 may be the first output data F_{b, out} of the transformer group 400.

FIG. 5 is a block diagram of a structure of a transformer layer, according to an embodiment.

A transformer layer 500 of FIG. 5 may include and/or may be similar in many respects to one of the one or more transformer layers 420 of FIG. 4, and may include additional features not mentioned above. Consequently, repeated descriptions of the transformer layer 500 described above with reference to FIG. 4 may be omitted for the sake of brevity.

Referring to FIG. 5, the transformer layer 500 may include a first normalization layer 510, a patch splitting module 520, an attention module 530, a patch merging module 540, a first summation layer 550, a second normalization layer 560, a multi-layer perceptron (MLP) module 570, and a second summation layer 580.

According to an embodiment, the first normalization layer 510 may normalize first input data F_{l, Q} and second input data F_{l, KV}. The first input data F_{l, Q} input to the transformer layer 500 may be the first input data s₃F_{b, Q} input to the one or more transformer layers 420. The second input data F_{l, KV} input to the transformer layer 500 may be the second input data F_{b, KV} input to the one or more transformer layers 420. Normalized first input data and second input data may be input to the patch splitting module 520.

For example, the first normalization layer 510 may normalize the first input data F_{l, Q} so that a sum of the first input data F_{l, Q} input to the transformer layer 500 is 1. The first normalization layer 510 may normalize the second input data F_{l, KV} so that a sum of the second input data F_{l, KV} input to the transformer layer 500 is 1. However, a normalization method performed by the first normalization layer 510 is not limited thereto.

According to an embodiment, the patch splitting module 520 may split each of the first input data and the second input data input to the patch splitting module 520 into a plurality of patches of a predetermined size. The first input data input to the patch splitting module 520 may be the first input data F_{l, Q} normalized by the first normalization layer 510. The second input data input to the patch splitting module 520 may be the second input data F_{l, KV} normalized by the first normalization layer 510. According to an embodiment, the size of each patch may be determined by considering hardware performance, memory size, or the like. For example, the larger the size of each patch, the greater the computational cost. According to an embodiment, the shape of a patch may be square (e.g., M×M). However, embodiments of the present disclosure are not limited thereto. For example, the shape of the patch may also be rectangular (e.g., M×N).

Because the first input data input to the patch splitting module 520 is first input data scaled by the third scaling module 410 of FIG. 4, the first input data may have a different size from the second input data input to the patch splitting module 520. Therefore, the first input data input to the patch splitting module 520 may be split into a larger number of patches than the second input data input to the patch splitting module 520. For example, when the size of the first input data input to the patch splitting module 520 is H′×W′, the size of the second input data input to the patch splitting module 520 may be H×W, and the size of the patch may M×M, the first input data input to the patch splitting module 520 may be split into H′W′/M²-patches, and the second input data input to the patch splitting module 520 may be split into HW/M²-patches.

According to an embodiment, the attention module 530 may perform attention on first input data and second input data that are input to the attention module 530. The first input data fed input to the attention module 530 may be a plurality of patches obtained by normalizing and then splitting the first input data F_{l, Q} input to the transformer layer 500. The second input data fed input to the attention module 530 may be a plurality of patches obtained by normalizing and then splitting the second input data F_{l, KV} input to the transformer layer 500.

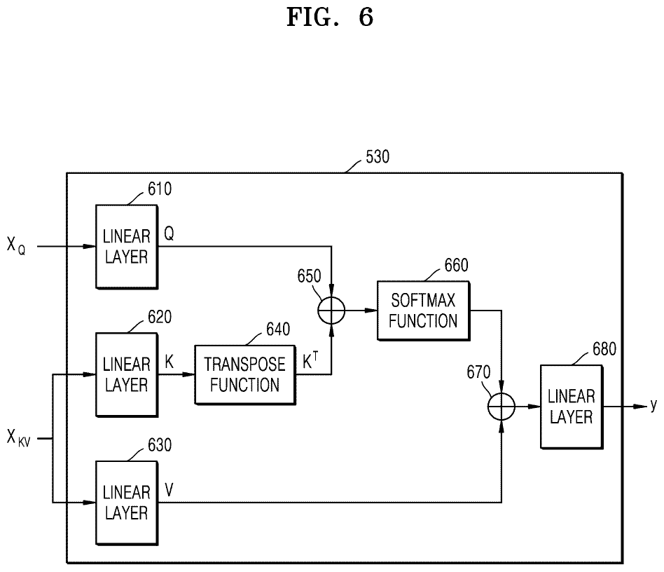

According to an embodiment, the attention operation may include an operation of obtaining query data Q, key data K, and value data V, based on input data, calculating a weight corresponding to a correlation between the query data Q and the key data K, and applying the weight to the value data V. The attention operation is further described with reference to FIG. 6.

According to an embodiment, the patch merging module 540 may merge first input data input to the patch merging module 540 and merge second input data. An operation of the patch merging module 540 may be understood as the inverse of the operation of the patch splitting module 520. The first input data input to the patch merging module 540 may be a result of the attention performed by the attention module 530. The second input data input to the patch merging module 540 may be the second input data input to the attention module 530.

According to an embodiment, the first summation layer 550 may perform an element-wise summation operation between first output data output by the patch merging module 540 and the first input data input to the transformer layer 500. Output data from the first summation layer 550 may be input to the second normalization layer 560.

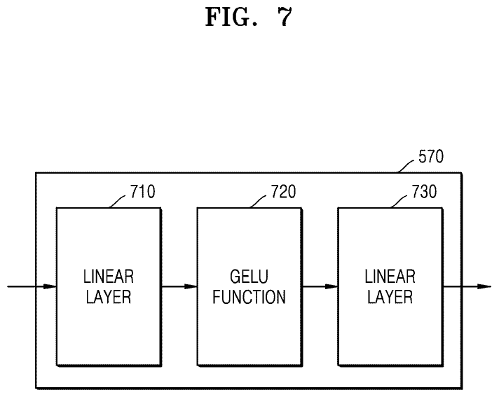

According to an embodiment, the second normalization layer 560 may normalize the output data from the first summation layer 550. For example, the second normalization layer 560 may normalize the output data from the first summation layer 550 so that a sum of the output data from the first summation layer 550 is one (1). However, a normalization method performed by the second normalization layer 560 is not limited thereto. Data normalized by the second normalization layer 560 may be input to the MLP module 570. The MLP module 570 is further described with reference to FIG. 7.

According to an embodiment, the second summation layer 580 may perform an element-wise summation operation between output data of the first summation layer 550 and output data of the MLP module 570. The output data of the second summation layer 580 may be first output data F_{l, out} of the transformer layer 500.

According to an embodiment, the transformer layer 500 may output second output data F_{l+1, KV}. The second output data of the transformer layer 500 may be second output data of the patch merging module 540. Because the second input data F_{l, KV} of the transformer layer 500 is normalized by the first normalization layer 510 and processed by the patch splitting module 520 and the patch merging module 540, the first output data F_{l+1, KV} of the transformer layer 500 may be the same as the normalized first input data F_{l, KV} of the transformer layer 500.

FIG. 6 is a block diagram of a structure of an attention module, according to an embodiment.

Referring to FIG. 6, the attention module 530 may include a first linear layer 610, a second linear layer 620, a third linear layer 630, a transpose function 640, a first multiplication layer 650, a softmax function 660, a second multiplication layer 670, and a fourth linear layer 680.

According to an embodiment, the first linear layer 610 may obtain query data Q corresponding to first input data X_{Q} input to the attention module 530, by calculating a product between the first input data X_{Q} and a weight matrix included in the first linear layer 610. The first input data X_{Q} input to the attention module 530 may be a plurality of patches obtained by splitting the first input data F_{l, Q} input to the transformer layer 500. According to an embodiment, the first linear layer 610 may include a 1×1 convolutional layer.

According to an embodiment, the second linear layer 620 may obtain key data K corresponding to second input data x_{KV} input to the attention module 530, by calculating a product between the second input data x_{KV} and a weight matrix included in the second linear layer 620. The second input data x_{KV} input to the attention module 530 may be a plurality of patches obtained by splitting the second input data F_{l, KV} input to the transformer layer 500. According to an embodiment, the second linear layer 620 may include a 1×1 convolutional layer.

According to an embodiment, the third linear layer 630 may obtain value data V corresponding to the second input data x_{KV} input to the attention module 530, by calculating a product between the second input data x_{KV} and a weight matrix included in the third linear layer 630. The second input data x_{KV} input to the attention module 530 may be a plurality of patches obtained by splitting the second input data F_{l, KV} input to the transformer layer 500. According to an embodiment, the third linear layer 630 may include a 1×1 convolutional layer.

According to an embodiment, the transpose function 650 may transpose the key data K to generate transposed key data K^{T}.

According to an embodiment, the first multiplication layer 650 may perform an element-wise multiplication operation between the query data Q and the transposed key data K^{T}.

According to an embodiment, the second multiplication layer 670 may perform an element-wise multiplication operation between an output of the first multiplication layer 650 to which the softmax function 660 is applied and the value data V. The output of the first multiplication layer 650 to which the softmax function 660 is applied may be understood as a weight representing a correlation between the query data Q and the key data K, and an operation of the second multiplication layer 670 may be understood as a weighted summation of the weight and the value data V.

According to an embodiment, the fourth linear layer 680 may perform a multiplication operation between an output of the second multiplication layer 670 and a weight matrix included in the fourth linear layer 680. According to an embodiment, the fourth linear layer 680 may include a 1×1 convolutional layer.

FIG. 7 is a block diagram of a structure of an MLP module, according to an embodiment.

Referring to FIG. 7, the MLP module 570 may include a first linear layer 710, a Gaussian Error Linear Unit (GELU) function 720, and a second linear layer 730.

According to an embodiment, the first linear layer 710 may perform a multiplication operation between data input to the first linear layer 710 and a weight matrix included in the first linear layer 710.

According to an embodiment, the second linear layer 730 may perform a multiplication operation between output data of the first linear layer 710 to which the GELU function 720 is applied and a weight matrix included in the second linear layer 730.

In FIG. 7, the MLP 570 is illustrated as including the GELU activation function 720. However, the type of activation function is not limited thereto, and various activation functions, such as, but not limited to, sigmoid, Rectified Linear Unit (ReLU), Tanh, Leaky ReLu, Parametric ReLU (PReLU), and an Exponential Linear Unit (ELU), may be used.

In the descriptions of FIGS. 1, 2, 3A, 3B, and 4 through 7, an image processing network 100 is described as including the first through third scaling modules 230, 310, and 410 each scaling input data. However, as described above, a method, performed by the image processing network 100, of transforming input data is not limited thereto. For example, instead of the first to third scaling modules 230, 310, and 410, the image processing network 100 may include a transformation module and/or network capable of subjecting input data to a similarity transformation, a Euclidean transformation, an affine transformation, or a projective transformation.

FIG. 8 illustrates a scaling factor, according to an embodiment.

Referring to FIG. 8, a table 800 showing an example of a scale factor when the size of the second image 20 is four (4) times the size of the first image 10, the image processing network 100 includes three (3) transformer groups, and each transformer group includes four (4) transformer blocks. In the table 800 of FIG. 8, a “scale factor of Q” may correspond to the scale factor ss of the third scaling module 410 of FIG. 4, and a “scale factor of K (and V)” may correspond to the scale factor s₂ of the second scaling module 310 of FIG. 3A. In the example of FIG. 8, because the size of the second image 20 is four (4) times the size of the first image 10, the scale factor s₁ of the first scaling module 230 may be four (4). In the table of FIG. 8, the smaller the number of a transformer block and the number of a transformer group, the closer the transformer block and transformer group are to an input data (e.g., the first image 10) side.

For example, in FIG. 8, a scale factor of a transformer group #1 is 2.0, and respective scale factors of transformer blocks #4 through #7 are 2.25, 2.5, 2.75, and 3.0, respectively. Such setting of scale factors may be understood as the first input data x_{Q} of the attention modules 530 included in the transformer blocks #4 through #7 being obtained by scaling the first image 10 2.25 times, 2.5 times, 2.75 times, and 3.0 times, respectively, and the second input data x_{KV} of attention modules included in the transformer blocks #4 through #7 being obtained by scaling the first image 10 2.0 times.

In such a case, attention modules 530 included in the transformer block #4 may obtain query data Q from the first image 10 scaled 2.25 times, obtain key data K and value data V from the first image 10 scaled 2.0 times, and perform attention operations based on the obtained query data Q, the obtained key data K and the obtained value data V. In the attention operations, a weight corresponding to a correlation between query data Q and key data K obtained from each of the first images 10 scaled by different scale factors are calculated, and thus the image processing network 100 may utilize another object having a different size (e.g., having the same size when being scaled by different scale factors) from a target object included in the first image 10 in order to process the target object.

In FIG. 8, scale ratios (Q/K) corresponding to the transformer blocks #0 through #3 included in the transformer group #0 are 1.25, 1.5, 1.75, and 2.0, respectively. In such case, the transformer blocks #0 through #3 may perform image processing on the target object by utilizing a similar object to the target object when scaled by the scale ratio Q/K. For example, in the attention modules included in the transformer block #0, a weight between the key data K obtained from a first patch including the target object and the query data Q obtained from a second patch including a similar object to the target object when scaled by 1.25 times may be calculated to be large. Similarly, in the attention modules included in the transformer block #1, a weight between the key data K obtained from a first patch including the target object and the query data Q obtained from a third patch including a similar object to the target object when scaled by 1.5 times may be calculated to be large.

According to an embodiment, when one transformer group includes a plurality of transformer blocks, each of the scale factors s₃ of the plurality of third scaling modules 410 included in the same transformer group may be determined such that a scale ratio (e.g., s₃/s₂) differs by a predetermined value with respect to the scale factor s₂ of the second scaling module 310. In such a case, the predetermined value may be a constant value for each transformer group. For example, in FIG. 8, scale ratios corresponding to transformer blocks #0 through #3 included in the transformer group #0 are 1.25, 1.5, 1.75, and 2.0, respectively, and all differ from each other by 0.25, and scale ratios corresponding to transformer blocks #4 through #7 included in the transformer group #1 are 1.125, 1.125, 1.375, and 1.5, respectively, and all differ from each other by 0.125.

According to an embodiment, for a plurality of transformer groups, a difference between the scale ratios s₃/s₂ of the scale factors s₃ of the third scaling modules 410 to the scale factor s₂ of the second scaling module 310 may decrease in a direction toward an output terminal. For example, in FIG. 8, the scale ratios of the transformer group #0 are 1.25, 1.5, 1.75, and 2.0, and a difference between the scale ratios is 0.25. The scale ratios of the transformer group #1 are 1.125, 1.25, 1.375, and 1.5, and a difference between the scale ratios is 0.125. The scale ratios of the transformer group #2 are 1.083, 1.167, 1.25, and 1.33, and a difference between the scale ratios is 0.082 on average. That a difference between scale ratios decreases in a direction toward the output terminal may be understood as the image processing network 100 processing the first image 10 by using a coarse-to-fine method. That is, the image processing network 100 may search for and utilize a similar object to the target object while gradually reducing an interval between scale factors in order to achieve image processing with respect to the target object.

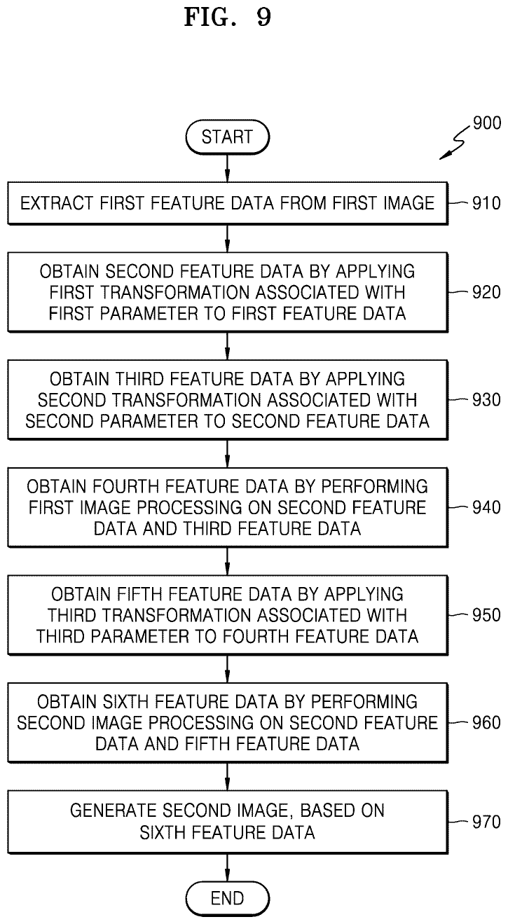

FIG. 9 is a flowchart of an image processing method, according to an embodiment.

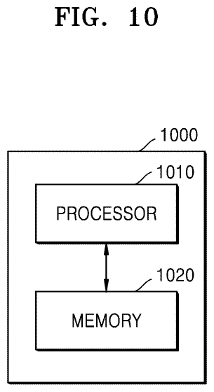

An image processing method 900 of FIG. 9 may be performed by an image processing apparatus 1000 of FIG. 10.

In operation 910, the image processing apparatus 1000 may extract first feature data from the first image 10. Operation 910 may correspond to an operation of the first feature extraction module 110.

In operation 920, the image processing apparatus 1000 may obtain second feature data by applying a first transformation associated with a first parameter to the first feature data. According to an embodiment, the first transformation may be any one of a scaling transformation, a similarity transformation, a Euclidean transformation, an affine transformation, or a projective transformation. When the first transformation is scaling, operation 920 may correspond to an operation of the second scaling module 310.

In operation 930, the image processing apparatus 1000 may obtain third feature data by applying a second transformation associated with a second parameter to the second feature data. According to an embodiment, the second transformation may be any one of a scaling transformation, a similarity transformation, a Euclidean transformation, an affine transformation, or a projective transformation. When the second transformation is scaling, operation 930 may correspond to an operation of the third scaling module 410 included in one transformer block 400 among the one or more transformer blocks 320.

In operation 940, the image processing apparatus 1000 may obtain fourth feature data by performing first image processing on the second feature data and the third feature data. Operation 940 may correspond to an operation of the one or more transformer layers 420 included in the transformer block 400 that performed operation 930.

In operation 950, the image processing apparatus 1000 may obtain fifth feature data by applying a third transformation associated with a third parameter to the fourth feature data. According to an embodiment, the third transformation may be any one of a scaling transformation, a similarity transformation, a Euclidean transformation, an affine transformation, or a projective transformation. When the third transformation is scaling, operation 950 may correspond to an operation of the third scaling module 410 included in a transformer block 400 that is next to the transformer block 400 that performed operation 930.

In operation 960, the image processing apparatus 1000 may obtain sixth feature data by performing second image processing on the second feature data and the fifth feature data. Operation 950 may correspond to an operation of the one or more transformer layers 420 included in the transformer block 400 that performed operation 950.

In operation 970, the image processing apparatus 1000 may generate a second image, based on the sixth feature data. Operation 970 may correspond to an operation of the image restoration module 130.

FIG. 10 is a block diagram of an image processing apparatus, according to an embodiment.

The image processing apparatus 1000 of FIG. 10 may process a first image by using the image processing network 100.

Referring to FIG. 10, the image processing apparatus 1000 may include a processor 1010 and a memory 1020. However, the components of the image processing apparatus 1000 are not limited thereto. For example, the image processing apparatus 1000 may further include a display that displays the first image 10 and/or the second image 20.

According to an embodiment, the processor 1010 may process data according to a predefined operating rule or an artificial intelligence model by executing one or more instructions stored in the memory 1020. For example, the processor 1010 may be a general-purpose processor such as, but not limited to, a central processing unit (CPU), an application processor (AP), or a digital signal processor (DSP), a graphics-only processor such as, but not limited to, a graphics processing unit (GPU) or a vision processing unit (VPU), or an artificial intelligence (AI)-only processor such as, but not limited to, a neural processing unit (NPU). According to an embodiment, the processor 1010 may be circuitry, such as, but not limited to, a System on Chip (SoC) or an Integrated Circuit (IC), executing one or more instructions and performing an operation corresponding to the instructions.

According to an embodiment, the processor 1010 may include a plurality of processors. The plurality of processors may divide and execute a plurality of instructions stored in the memory 1020. For example, a first processor among the plurality of processors may execute a first instruction corresponding to a first operation (e.g., operation 910 of FIG. 9) of the image processing apparatus 1000, and a second processor among the plurality of processors may execute a second instruction corresponding to a second operation (e.g., operation 920 of FIG. 9) of the image processing apparatus 1000.

According to an embodiment, the memory 1020 may store one or more instructions for image processing. The one or more instructions, when executed by the processor 1010, may cause the image processing apparatus 1000 to perform the image processing method 900.

According to an embodiment, the memory 1020 may be composed of storage media, such as, but not limited to, read-only memory (ROM), random access memory (RAM), hard disks, compact disc (CD)-ROM, and digital versatile discs (DVDs), or a combination thereof. The memory 1020 may be implemented as a volatile memory, a non-volatile memory, or a combination of a volatile memory and a non-volatile memory. The memory 1020 may not exist separately but may be included in the processor 1010.

According to an embodiment, the memory 1020 may include a plurality of memories. The plurality of memories may divide and execute a plurality of instructions. For example, a first memory among the plurality of memories may store the first instruction corresponding to a first operation (e.g., operation 910 of FIG. 9) of the image processing apparatus 1000, and a second memory among the plurality of memories may store the second instruction corresponding to a second operation (e.g., operation 920 of FIG. 9) of the image processing apparatus 1000.

While the present disclosure has been described with reference to illustrative embodiments, this description is not intended to be construed in a limiting sense. Various modifications and combinations of the illustrative embodiments, as well as other embodiments of the invention, may be apparent to persons skilled in the art upon reference to the description. It is therefore intended that the appended claims encompass any such modifications or embodiments.

What is claimed is:

1. A method of processing an image, the method comprising:
extracting first feature data from a first image;
obtaining second feature data by applying, to the first feature data, a first transformation associated with a first parameter;
obtaining third feature data by applying, to the second feature data, a second transformation associated with a second parameter;
obtaining fourth feature data by performing first image processing on the second feature data and the third feature data;
obtaining fifth feature data by applying, to the fourth feature data, a third transformation associated with a third parameter;
obtaining sixth feature data by performing second image processing on the second feature data and the fifth feature data; and
generating a second image based on the sixth feature data,
wherein the method further comprises:
determining the first parameter, the second parameter, and the third parameter based on a first difference between a first ratio of the second parameter to the first parameter and a second ratio of the third parameter to the first parameter being greater than or equal to a predetermined value.

2. The method of claim 1, wherein the performing of the first image processing comprises:
obtaining query data based on the third feature data;
obtaining key data and value data based on the second feature data;
calculating a weight matrix based on the query data and the key data; and
obtaining the fourth feature data based on the weight matrix and the value data.

3. The method of claim 1, wherein the generating of the second image comprises:
determining a fourth parameter based on the first parameter, a resolution of the first image, and a resolution of the second image;
obtaining seventh feature data by applying, to the second feature data, a fourth transformation associated with the fourth parameter;
obtaining eighth feature data by applying, to the sixth feature data, a fifth transformation associated with a fifth parameter;
obtaining ninth feature data by performing third image processing on the seventh feature data and the eighth feature data;
obtaining tenth feature data by applying, to the ninth feature data, a sixth transformation associated with a sixth parameter;
obtaining eleventh feature data by performing fourth image processing on the seventh feature data and the tenth feature data; and
generating the second image based on the eleventh feature data.

4. The method of claim 3, further comprising:
determining the fifth parameter and the sixth parameter based on a second difference between a third ratio of the fifth parameter to the fourth parameter and a fourth ratio of the sixth parameter to the fourth parameter being less than the first difference.

5. The method of claim 3, wherein the generating of the second image comprises:
obtaining twelfth feature data by applying, to the sixth feature data, a seventh transformation associated with a seventh parameter;
obtaining thirteenth feature data by performing fifth image processing on the sixth feature data and the twelfth feature data;
obtaining fourteenth feature data by applying, to the thirteenth feature data, an eighth transformation associated with an eighth parameter;
obtaining fifteenth feature data by performing sixth image processing on the sixth feature data and the fourteenth feature data; and
generating the second image, based on the fifteenth feature data.

6. The method of claim 5, further comprising:
determining the seventh parameter and the eighth parameter based on a third difference between a fifth ratio of the seventh parameter to the second parameter and a sixth ratio of the eighth parameter to the second parameter being less than the first difference between the first ratio and the second ratio.

7. The method of claim 5, wherein each of the first transformation, the second transformation, the third transformation, the fourth transformation, the fifth transformation, the sixth transformation, the seventh transformation, and the eighth transformation comprises a scaling transformation, and
wherein each of the first parameter, the second parameter, the third parameter, the fourth parameter, the fifth parameter, the sixth parameter, the seventh parameter, and the eighth parameter comprises a scale factor.

8. An image processing apparatus, comprising:
one or more processors comprising processing circuitry; and
memory storing instructions,
wherein the instructions, when executed by the one or more processors individually or collectively, cause the image processing apparatus to:
extract first feature data from a first image;
obtain second feature data by applying, to the first feature data, a first transformation associated with a first parameter;
obtain third feature data by applying, to the second feature data, a second transformation associated with a second parameter;
obtain fourth feature data by performing first image processing on the second feature data and the third feature data;
obtain fifth feature data by applying, to the fourth feature data, a third transformation associated with a third parameter;
obtain sixth feature data by performing second image processing on the second feature data and the fifth feature data;
generate a second image, based on the sixth feature data; and
determine the first parameter, the second parameter, and the third parameter based on a first difference between a first ratio of the second parameter to the first parameter and a second ratio of the third parameter to the first parameter being greater than or equal to a predetermined value.

9. The image processing apparatus of claim 8, wherein the instructions, when executed by the one or more processors individually or collectively, further cause the image processing apparatus to:
obtain query data based on the third feature data;
obtain key data and value data, based on the second feature data;
calculate a weight matrix based on the query data and the key data; and
obtain the fourth feature data based on the weight matrix and the value data.

10. The image processing apparatus of claim 8, wherein the instructions, when executed by the one or more processors individually or collectively, further cause the image processing apparatus to:
determine a fourth parameter based on the first parameter, a resolution of the first image, and a resolution of the second image;
obtain seventh feature data by applying, to the second feature data, a fourth transformation associated with the fourth parameter;
obtain eighth feature data by applying, to the sixth feature data, a fifth transformation associated with a fifth parameter;
obtain ninth feature data by performing third image processing on the seventh feature data and the eighth feature data;
obtain tenth feature data by applying, to the ninth feature data, a sixth transformation associated with a sixth parameter;
obtain eleventh feature data by performing fourth image processing on the seventh feature data and the tenth feature data; and
generate the second image based on the eleventh feature data.

11. The image processing apparatus of claim 10, wherein the instructions, when executed by the one or more processors individually or collectively, further cause the image processing apparatus to:
determine the fifth parameter and the sixth parameter based on a second difference between a third ratio of the fifth parameter to the fourth parameter and a fourth ratio of the sixth parameter to the fourth parameter being less than the first difference.

12. The image processing apparatus of claim 10, wherein the instructions, when executed by the one or more processors individually or collectively, further cause the image processing apparatus to:
obtain twelfth feature data by applying, to the sixth feature data, a seventh transformation associated with a seventh parameter;
obtain thirteenth feature data by performing fifth image processing on the sixth feature data and the twelfth feature data;
obtain fourteenth feature data by applying, to the thirteenth feature data, an eighth transformation associated with an eighth parameter;
obtain fifteenth feature data by performing sixth image processing on the sixth feature data and the fourteenth feature data; and
generate the second image based on the fifteenth feature data.

13. The image processing apparatus of claim 12, wherein the instructions, when executed by the one or more processors individually or collectively, further cause the image processing apparatus to:
determine the seventh parameter and the eighth parameter based on a third difference between a fifth ratio of the seventh parameter to the second parameter and a sixth ratio of the eighth parameter to the second parameter being less than the first difference.

14. The image processing apparatus of claim 12, wherein each of the first transformation, the second transformation, the third transformation, the fourth transformation, the fifth transformation, the sixth transformation, the seventh transformation, and the eighth transformation comprises a scaling transformation, and
wherein each of the first parameter, the second parameter, the third parameter, the fourth parameter, the fifth parameter, the sixth parameter, the seventh parameter, and the eighth parameter comprises a scale factor.

15. A non-transitory computer-readable recording medium having recorded thereon one or more instructions for processing an image that, when executed by at least one processor of a device, cause the device to:
extract first feature data from a first image;
obtain second feature data by applying, to the first feature data, a first transformation associated with a first parameter;
obtain third feature data by applying, to the second feature data, a second transformation associated with a second parameter;
obtain fourth feature data by performing first image processing on the second feature data and the third feature data;
obtain fifth feature data by applying, to the fourth feature data, a third transformation associated with a third parameter;
obtain sixth feature data by performing second image processing on the second feature data and the fifth feature data;
generate a second image, based on the sixth feature data; and
determine the first parameter, the second parameter, and the third parameter based on a first difference between a first ratio of the second parameter to the first parameter and a second ratio of the third parameter to the first parameter being greater than or equal to a predetermined value.

16. The non-transitory computer-readable recording medium of claim 15, wherein the one or more instructions, when executed by the at least one processor of the device, further cause the device to:
obtain query data based on the third feature data;
obtain key data and value data, based on the second feature data;
calculate a weight matrix based on the query data and the key data; and
obtain the fourth feature data based on the weight matrix and the value data.

17. The non-transitory computer-readable recording medium of claim 15, wherein the one or more instructions, when executed by the at least one processor of the device, further cause the device to:
determine a fourth parameter based on the first parameter, a resolution of the first image, and a resolution of the second image;
obtain seventh feature data by applying, to the second feature data, a fourth transformation associated with the fourth parameter;
obtain eighth feature data by applying, to the sixth feature data, a fifth transformation associated with a fifth parameter;
obtain ninth feature data by performing third image processing on the seventh feature data and the eighth feature data;
obtain tenth feature data by applying, to the ninth feature data, a sixth transformation associated with a sixth parameter;
obtain eleventh feature data by performing fourth image processing on the seventh feature data and the tenth feature data; and
generate the second image based on the eleventh feature data.

18. The non-transitory computer-readable recording medium of claim 17, wherein the one or more instructions, when executed by the at least one processor of the device, further cause the device to:
determine the fifth parameter and the sixth parameter based on a second difference between a third ratio of the fifth parameter to the fourth parameter and a fourth ratio of the sixth parameter to the fourth parameter being less than the first difference.

19. The non-transitory computer-readable recording medium of claim 15, wherein the one or more instructions, when executed by the at least one processor of the device, further cause the device to:
obtain twelfth feature data by applying, to the sixth feature data, a seventh transformation associated with a seventh parameter;
obtain thirteenth feature data by performing fifth image processing on the sixth feature data and the twelfth feature data;
obtain fourteenth feature data by applying, to the thirteenth feature data, an eighth transformation associated with an eighth parameter;
obtain fifteenth feature data by performing sixth image processing on the sixth feature data and the fourteenth feature data; and
generate the second image based on the fifteenth feature data.

20. The non-transitory computer-readable recording medium of claim 19, wherein the one or more instructions, when executed by the at least one processor of the device, further cause the device to:
determine the seventh parameter and the eighth parameter based on a third difference between a fifth ratio of the seventh parameter to the second parameter and a sixth ratio of the eighth parameter to the second parameter being less than the first difference.
